(19) United States
(12) Patent Application Publication
(10) Pub. No.: US 2021/0350047 A1
(43) Pub. Date: Nov. 11, 2021

(54) SIMULATION METHOD AND SIMULATION APPARATUS

(71) Applicant: CANON KABUSHIKI KAISHA, Tokyo (JP)

(72) Inventors: Tosiya Asano, Tochigi (JP); Junichi Seki, Kanagawa (JP); Yuichiro Oguchi, Tokyo (JP)

(21) Appl. No.: 17/382,572

(22) Filed: Jul. 22, 2021

Related U.S. Application Data
(63) Continuation of application No. PCT/JP2020/003017, filed on Jan. 28, 2020.

(30) Foreign Application Priority Data
Jan. 30, 2019 (JP) 2019-014483
Jan. 14, 2020 (JP) 2020-003952

(51) Int. Cl. G06F 30/20

(52) U.S. Cl. CPC G06F 30/20; B29C 59/02

(57) ABSTRACT

A simulation method of predicting a behavior of a curable composition in a process of bringing a plurality of droplets of the curable composition arranged on a first member and a second member into contact with each other and forming a film of the curable composition on the first member is disclosed. The method includes defining a computational grid formed by a plurality of computational elements so that a plurality of droplets of the curable composition fall within one computational element, and obtaining the behavior of the curable composition in each computational element in accordance with a model corresponding to a state of the curable composition in each computational element.

### CROSS-REFERENCE TO RELATED APPLICATIONS

This application is a Continuation of International Patent Application No. PCT/JP2020/003017, filed Jan. 28, 2020, which claims the benefit of Japanese Patent Application No. 2019-014483 filed Jan. 30, 2019, and No. 2020-003952 filed Jan. 14, 2020, which are hereby incorporated by reference herein.

### BACKGROUND OF THE INVENTION

### Field of the Invention

The present invention relates to a simulation method, a simulation apparatus, and a non-transitory computer readable medium storing a program.

### Background Art

There is provided a film forming method of forming a film made of a cured product of a curable composition on a substrate by arranging the curable composition on the substrate, bringing the curable composition and a mold into contact with each other, and curing the curable composition. Such film forming method can be applied to an imprint method and a planarization method. In the imprint method, by using a mold having a pattern, the pattern of the mold is transferred to a curable composition on a substrate. In the planarization method, by using a mold having a flat surface, a film having a flat upper surface is formed by bringing a curable composition on a substrate and the flat surface into contact with each other and curing the curable composition.

The curable composition can be arranged in the form of droplets on the substrate. After that, the mold can be pressed against the droplets of the curable composition on the substrate. This spreads the droplets to form a film of the curable composition. In this process, it is important to form a film of the curable composition with a uniform thickness and to include no bubble in the film. To achieve this, the arrangement of the droplets, a method and a condition for pressing the mold against the droplets, and the like can be adjusted. To implement this adjustment operation by trial and error including film formation using a film forming apparatus, enormous time and cost are required. To cope with this, it is desired that a simulator for supporting such adjustment operation appears.

PTL 1 describes a simulation method for predicting wet spreading and coalescence of a plurality of droplets arranged on a pattern forming surface. In this simulation method, an analysis surface obtained by modeling the pattern forming surface is divided into a plurality of analysis cells, and a droplet is arranged for each drop site on the analysis surface. PTL 1 describes that the drop sites are defined as regions obtained by dividing the surface into an m x n grid pattern, and are based on a concept different from that of the analysis cells.

Normally, when the behaviors of droplets are computed, it is necessary to define computational elements (analysis cells) each sufficiently smaller than the dimensions (size) of each droplet. However, computation of the behaviors of droplets over the entire wide region such as one shot region while defining such small computational elements is extremely unrealistic, and it may be impossible to obtain a computation result within an allowable time.

### CITATION LIST

### Patent Literature

PTL 1: Japanese Patent No. 5599356

### SUMMARY OF THE INVENTION

The present invention provides a technique advantageous in computing, within a shorter time, the behavior of a curable composition in a process of forming a film of the curable composition.

One aspect of the present invention relates to a simulation method of predicting a behavior of a curable composition in a process of bringing a plurality of droplets of the curable composition arranged on a first member and a second member into contact with each other and forming a film of the curable composition on the first member, and the simulation method defines a computational grid formed by a plurality of computational elements so that a plurality of droplets of the curable composition fall within one computational element, and obtains the behavior of the curable composition in each computational element in accordance with a model corresponding to a state of the curable composition in each computational element.

### BRIEF DESCRIPTION OF THE DRAWINGS

FIG. 1 is a view showing the arrangements of a film forming apparatus and a simulation apparatus according to an embodiment;

FIG. 2 is a view for explaining matters that can be considered in computation for predicting the behavior of a curable composition;

FIG. 3 is a view exemplifying a computational grid to be defined when simulating the behavior of the curable composition between a substrate and a mold by a general method;

FIG. 4 is a flowchart illustrating a simulation method executed by the simulation apparatus according to the embodiment;

FIG. 5 is a view exemplifying computational elements according to the embodiment;

FIG. 6A is a view exemplifying assignment or dispensation of droplets to computational elements;

FIG. 6B is a view exemplifying assignment or dispensation of droplets to computational elements;

FIG. 7 is a view for explaining matters that can be considered in computation for predicting the behavior of the curable composition;

FIG. 8 is a view exemplifying a height h_{drp,i} of droplets and a distance hᵢ between the substrate and the mold;

FIG. 9 is a view for explaining a ratio αᵢ between the area of a droplet arrangement region in a computational element i and the area of the computational element i;

FIG. 10A is a view exemplifying a plurality of states of the curable composition;

FIG. 10B is a view exemplifying the plurality of states of the curable composition;

FIG. 10C is a view exemplifying the plurality of states of the curable composition;

FIG. 10D is a view exemplifying the plurality of states of the curable composition;

FIG. 10E is a view exemplifying the plurality of states of the curable composition;

FIG. 11 is a view showing an overview of a classification table in accordance with an arrangement pattern of droplets of the curable composition;

FIG. 12 is a view for explaining a method of creating a classification table by geometric computation;

FIG. 13A is a view exemplifying a pressure distribution p_{drp}(x, y);

FIG. 13B is a view exemplifying a pressure distribution p_{film}(x, y);

FIG. 13C is a view exemplifying the pressure distribution p_{film}(x, y);

FIG. 13D is a view showing the relationship between a tone and a pressure in a grayscale shown in FIGS. 13A to 13C;

FIG. 14A is a view for explaining droplets;

FIG. 14B is a view for explaining a liquid film;

FIG. 15 is a view exemplifying a method of deciding the pressure of the computational element;

FIG. 16A is a view for explaining variables;

FIG. 16B is a view for explaining variables;

FIG. 16C is a view for explaining variables;

FIG. 17 is a view for explaining variables;

FIG. 18A is a view for explaining the flow of the curable composition between computational elements;

FIG. 18B is a view for explaining the flow of the curable composition between the computational elements;

FIG. 19A is a view conceptually showing simultaneous equations to be solved according to the embodiment;

FIG. 19B is a view conceptually showing the simultaneous equations to be solved according to the embodiment; and

FIG. 19C is a view conceptually showing the simultaneous equations to be solved according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

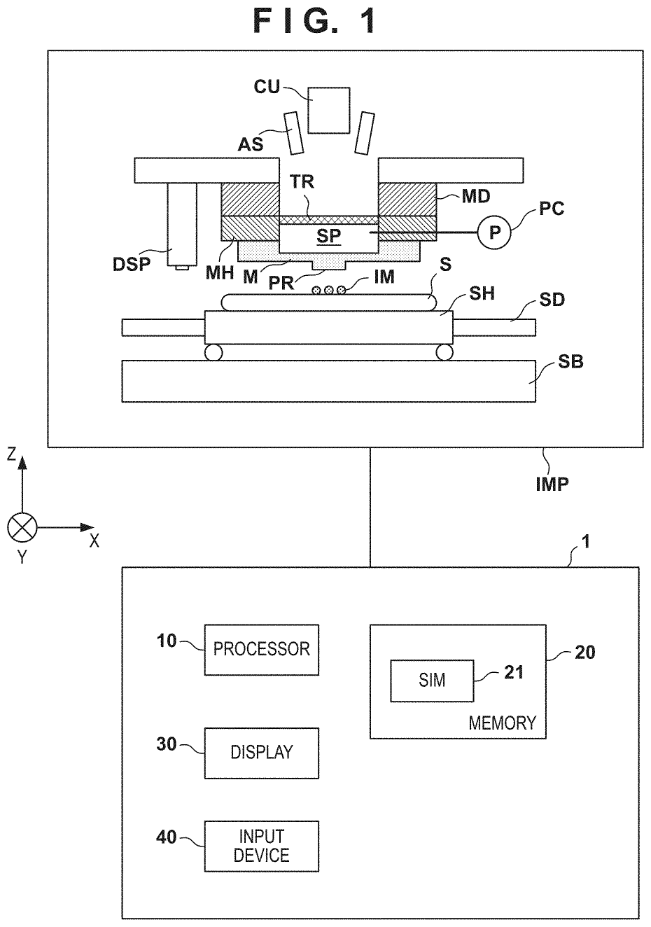

FIG. 1 shows the arrangements of a film forming apparatus IMP and a simulation apparatus 1 according to an embodiment. The film forming apparatus IMP executes a process of bringing a plurality of droplets of a curable composition IM arranged on a substrate S and a mold M into contact with each other and forming a film of the curable composition IM in a space between the substrate S and the mold M. The film forming apparatus IMP may be formed as, for example, an imprint apparatus or a planarization apparatus. The substrate S and the mold M are interchangeable, and a film of the curable composition IM may be formed in the space between the mold M and the substrate S by bringing a plurality of droplets of the curable composition IM arranged on the mold M and the substrate S into contact with each other. Therefore, the film forming apparatus IMP is comprehensively an apparatus that executes a process of bringing a plurality of droplets of the curable composition IM arranged on the first member and the second member into contact with each other and forming a film of the curable composition IM in a space between the first member and the second member. An example in which the first member serves as the substrate S and the second member serves as the mold M will be described below. However, the first member may serve as the mold M and the second member may serve as the substrate S. In this case, the substrate S and the mold M in the following description are interchanged.

The imprint apparatus can use the mold M having a pattern to transfer the pattern of the mold M to the curable composition IM on the substrate S. The imprint apparatus can use the mold M having a pattern region PR provided with a pattern. The imprint apparatus can bring the curable composition IM on the substrate S and the pattern region PR of the mold M into contact with each other, fill, with the curable composition, a space between the mold M and a region where the pattern of the substrate S is to be formed, and then cure the curable composition IM. This transfers the pattern of the pattern region PR of the mold M to the curable composition IM on the substrate S. For example, the imprint apparatus can form a pattern made of a cured product of the curable composition IM on each of a plurality of shot regions of the substrate S.

Using the mold M having a flat surface, the planarization apparatus can bring the curable composition IM on the substrate S and the flat surface into contact with each other, and cure the curable composition IM, thereby forming a film having a flat upper surface. The planarization apparatus can form a film made of a cured product of the curable composition IM on the entire region of the substrate S by normally using the mold M having a size that can cover the entire region of the substrate S.

As the curable composition, a material to be cured by receiving curing energy can be used. As the curing energy, an electromagnetic wave, heat, or the like can be used. The electromagnetic wave can include, for example, light selected from the wavelength range of 10 nm (inclusive) to 1 mm (inclusive) and, more specifically, infrared light, a visible light beam, or ultraviolet light. The curable composition can be a composition cured by light irradiation or heating. A photo-curable composition cured by light irradiation contains at least a polymerizable compound and a photopolymerization initiator, and may further contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component. The viscosity (the viscosity at 25° C.) of the curable composition is, for example, 1 mPa·s (inclusive) to 100 mPa·s (inclusive). As the material of the substrate, for example, glass, a ceramic, a metal, a semiconductor, a resin, or the like can be used. A member made of a material different from the substrate may be provided on the surface of the substrate, as needed. The substrate includes, for example, a silicon wafer, a compound semiconductor wafer, or silica glass.

In the specification and the accompanying drawings, directions will be indicated on an XYZ coordinate system in which directions parallel to the surface of the substrate S are defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving concerning the X-axis, the Y-axis, and the Z-axis means control or driving concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively. In addition, a position is information that can be specified based on coordinates on the X-, Y-, and Z-axes, and an orientation is information that can be specified by values on the θX-, θY-, and θZ-axes. Positioning means controlling the position and/or orientation.

The film forming apparatus IMP can include a substrate holder SH that holds the substrate S, a substrate driving mechanism SD that drives the substrate S by driving the substrate holder SH, and a support base SB that supports the substrate driving mechanism SD. In addition, the film forming apparatus IMP can include a mold holder MH that holds the mold M and a mold driving mechanism MD that drives the mold M by driving the mold holder MH. The substrate driving mechanism SD and the mold driving mechanism MD can form a relative driving mechanism that drives at least one of the substrate SD and the mold MD so as to adjust the relative position between the substrate S and the mold M. Adjustment of the relative position by the relative driving mechanism can include driving to bring the curable composition IM on the substrate S and the mold M into contact with each other and driving to separate the mold M from the cured curable composition IM. In addition, adjustment of the relative position by the relative driving mechanism can include alignment between the substrate S and the mold M. The substrate driving mechanism SD can be configured to drive the substrate S with respect to a plurality of axes (for example, three axes including the X-axis, Y-axis, and θZ-axis, and preferably six axes including the X-axis, Y-axis, Z-axis, θX-axis, θY-axis, and θZ-axis). The mold driving mechanism MD can be configured to drive the mold M with respect to a plurality of axes (for example, three axes including the Z-axis, θX-axis, and θY-axis, and preferably six axes including the X-axis, Y-axis, Z-axis, θX-axis, θY-axis, and θZ-axis).

The film forming apparatus IMP can include a curing device CU for curing the curable composition IM with which the space between the substrate S and the mold M is filled. For example, the curing device CU can irradiate the curable composition IM with the curing energy via the mold M, thereby curing the curable composition IM. The film forming apparatus IMP can include a transmissive member TR for forming a space SP on the rear side (the opposite side of a surface opposing the substrate S) of the mold M. The transmissive member TR is made of a material that transmits the curing energy from the curing device CU, thereby making it possible to irradiate the curable composition IM with the curing energy. The film forming apparatus IM can include a pressure control unit PC that controls deformation of the mold M in the Z-axis direction by controlling the pressure of the space SP. For example, when the pressure control unit PC makes the pressure of the space SP higher than the atmospheric pressure, the mold M can be deformed in a convex shape toward the substrate S.

The film forming apparatus IMP can include a dispenser DSP for arranging, supplying, or dispensing the curable composition IM on the substrate S. The substrate S on which the curable composition IM is arranged by another apparatus may be supplied to the film forming apparatus IMP. In this case, the film forming apparatus IMP need not include the dispenser DSP. The film forming apparatus IMP may include an alignment scope AS for measuring an alignment error between the substrate S (or the shot region of the substrate S) and the mold M.

The simulation apparatus 1 can execute computation of predicting the behavior of the curable composition IM in a process executed by the film forming apparatus IMP. More specifically, the simulation apparatus 1 can execute computation of predicting the behavior of the curable composition IM in the process of bringing the plurality of droplets of the curable composition IM arranged on the substrate S and the mold M into contact with each other and forming a film of the curable composition IM in the space between the substrate S and the mold M.

The simulation apparatus 1 can be formed by, for example, incorporating a simulation program 21 in a general-purpose or dedicated computer. Alternatively, the simulation apparatus 1 can be formed by a PLD (Programmable Logic Device) such as an FPGA (Field Programmable Gate Array) or an ASIC (Application Specific Integrated Circuit). In one example, the simulation apparatus 1 can be formed by preparing a computer including a processor 10, a memory 20, a display 30, and an input device 40 and storing the simulation program 21 in the memory 20. The memory 20 may be a semiconductor memory, a disk such as a hard disk, or a memory of another form. The simulation program 21 can be stored in a computer-readable memory medium or provided to the simulation apparatus 1 via a communication facility such as a telecommunication network.

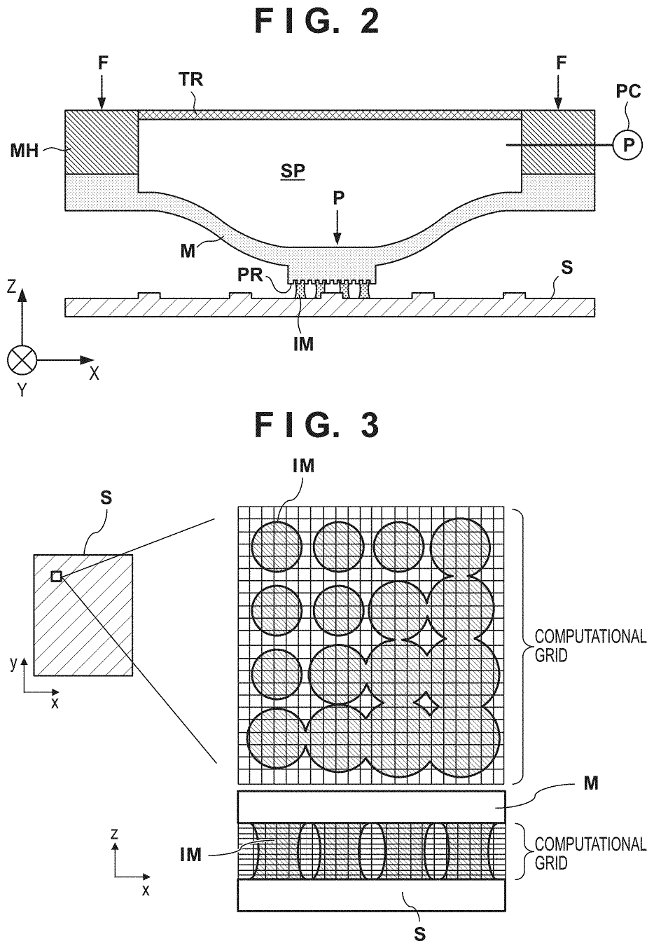

Matters that can be considered in computation for predicting the behavior of the curable composition will be described with reference to FIG. 2. A force from the mold M acts on the curable composition IM on the substrate 1. A force F from the mold driving unit MD can act on the mold M. Furthermore, a pressure P (a force by it) of the space SP controlled by the pressure control unit PC can act on the mold M. A force from the curable composition IM can also act on the mold M. The behavior of the curable composition IM is influenced by the force received from the mold M, the shape (unevenness) of the surface (for example, the surface of the pattern region PR of the mold M) of the mold M, and the shape (unevenness) of the surface of the substrate S.

FIG. 3 exemplifies a computational grid to be defined when simulating the behavior of the curable composition IM between the substrate S and the mold M by a general method. In this specification, the computational grid is an aggregate of computational elements as minimum units for computation. Referring to FIG. 3, each of a plurality of small rectangles arranged to form a grid is a computational element. A computational grid is defined in an analysis target region (for example, a shot region) of the substrate S. In a normal simulation method, to analyze the behaviors of the droplets of the curable composition IM, a computational grid formed by computational elements each sufficiently smaller than the dimensions of each droplet will be defined. However, if a computational grid formed by such small computational elements is defined, the computation amount is enormous, and it cannot be expected to obtain a computation result within an allowable time.

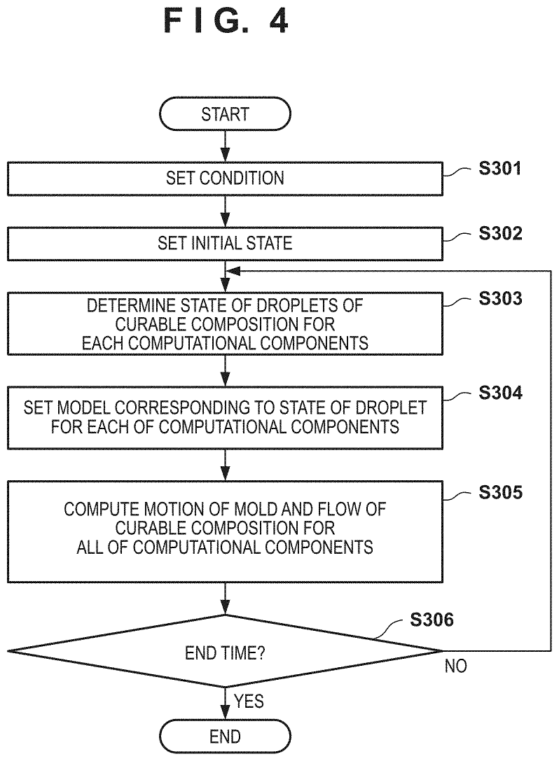

A simulation method executed by the simulation apparatus 1 will be described below with reference to FIG. 4. This simulation method can include steps S301, S302, S303, S304, S305 and S306. Step S301 is a step of setting a condition for simulation. Step S302 is a step of setting the initial state of the curable composition IM based on the condition set in step S301. Steps S301 and S302 may be understood as one step obtained by combining steps S301 and S302, for example, as a preparation step. Step S303 is a step of determining the state of the curable composition IM for each of a plurality of computational elements forming a computational grid. Step S304 is a step of setting, for each of the plurality of computational elements forming the computational grid, a model (for example, a formula) corresponding to the state of the curable composition IM determined in step S303. Step S305 is a step of computing the motion of the mold M and the flow of the curable composition IM for all the plurality of computational elements for each of which the model has been set in step S304. Steps S303, S304, and S305 are executed to compute the state of the mold M and the state of the curable composition IM at a given time. In step S306, it is determined whether the time in computation has reached an end time. If the time has not reached the end time, the time advances to a next time, and the process returns to step S303; otherwise, the simulation method ends. The simulation apparatus 1 may be understood as an aggregate of hardware components that execute steps S301, S302, S303, S304, S305 and S306, respectively.

Steps S301, S302, S303, S304, and S305 will be described in detail below.

In step S301, parameters necessary for simulation are set. The parameters can include the arrangement of the droplets of the curable composition IM on the substrate S, the volume of each droplet, the physical properties of the curable composition IM, information concerning unevenness (for example, information of the pattern of the pattern region PR) of the surface of the mold M, and information concerning unevenness of the surface of the substrate S. The parameters can include a time profile of a force applied to the mold M by the mold driving unit MD, and a profile of a pressure applied to the space SP (mold M) by the pressure control unit PC.

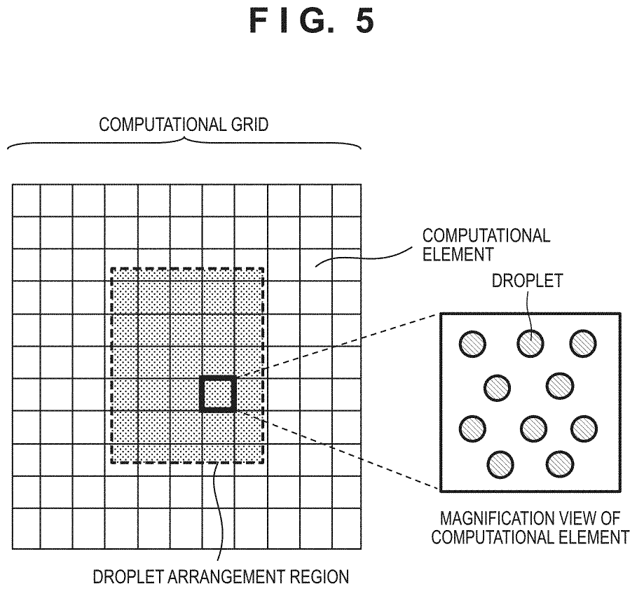

In step S302, the initial states of a plurality of computational elements forming a computational grid are set. Step S302 can include, for example, a definition step of defining a computational grid (computational elements), and an extraction step of extracting, for each computational element, the total volume of droplets, the volume of the concave portion of the substrate S and that of the mold M, the height of droplets, and the distance between the substrate and the mold. As exemplified in FIG. 5, a smallest rectangular region (droplet arrangement region) surrounding a region where droplets of the curable composition IM are arranged can be set as an analysis target region, and a computational grid can be set to include the analysis target region. In the definition step of defining the computational grid (computational elements), the computational grid formed by the plurality of computational elements can be defined so that a plurality (at least two) of droplets of the curable composition IM fall within one computational element. The computational grid can be defined based on, for example, the volume of each droplet of the curable composition IM or the arrangement of the droplets of the curable composition IM. By defining the computational grid formed by the plurality of computational elements so that a plurality of droplets of the curable composition IM fall within one computational element, it is possible to largely reduce the number of computational elements, thereby largely reducing the time taken for simulation.

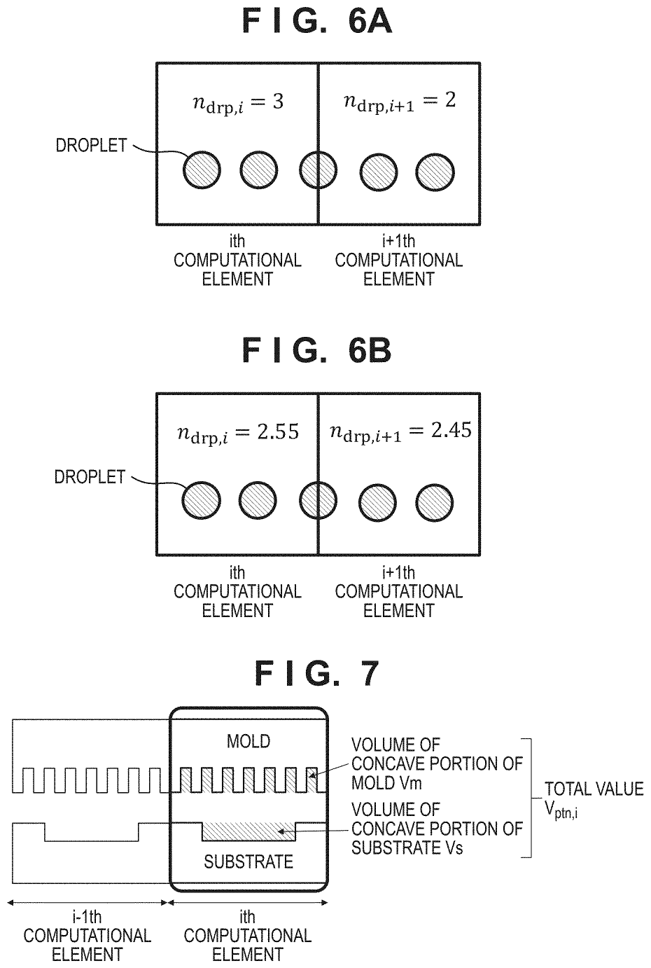

After the definition step, the extraction step can be executed. In the extraction step, a total volume V_{drp,i} of droplets included in each computational element can be computed based on the number n_{drp,i} of droplets of the curable composition IM included in each computational element. A subscript i represents an index for specifying a computational element. If one droplet is arranged across a plurality of computational elements, it is possible to deal with the droplet as if the entire droplet were included in a computational element to which the representative position (for example, the central position) of the droplet belongs, as exemplified in FIG. 6A. Alternatively, if one droplet is arranged across a plurality of computational elements, the droplet may be dispensed to the plurality of computational elements, to which the droplet belongs, in accordance with weighting corresponding to the central position of the droplet, as exemplified in FIG. 6B. In the extraction step, a volume V_{ptn,i} of the concave portion of the substrate S and that of the mold M can further be computed for each computational element. As exemplified in FIG. 7, the volume V_{ptn,i} is a sum of a volume Vs of the concave portion of the substrate S in the computational element and a volume Vm of the concave portion of the mold M in the computational element.

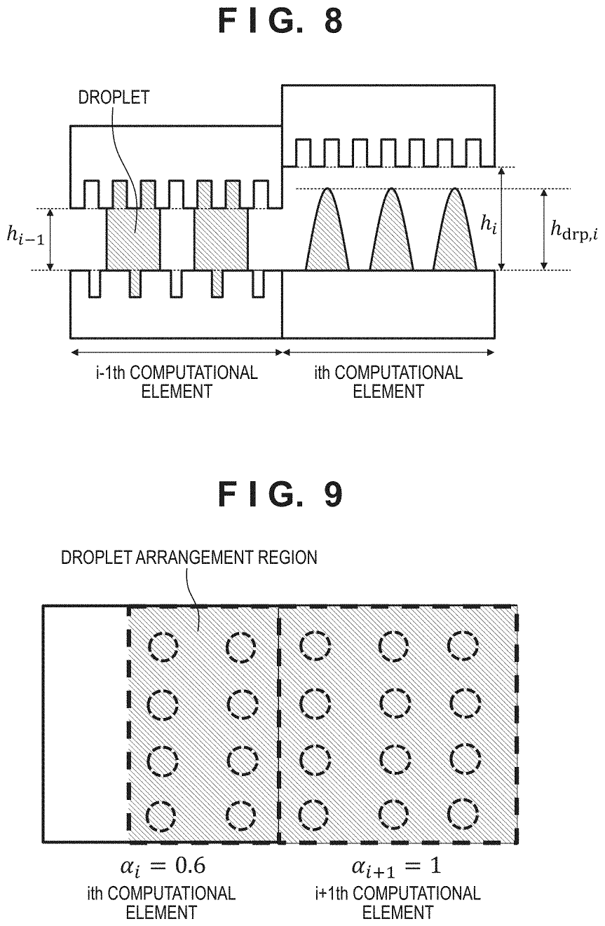

In the extraction step, a height h_{drp,i} of droplets and a distance hᵢ between the substrate S and the mold M are also computed for each computational element. FIG. 8 exemplifies the height h_{drp,i} of the droplets and the distance hᵢ between the substrate S and the mold M. The height h_{drp,i} of the droplets is a height representing the heights of the plurality of droplets in the computational element, and can be decided based on the heights of the plurality of droplets in the computational element. The height h_{drp,i} of the droplets may be, for example, the average value or maximum value of the heights of the plurality of droplets in the computational element, or another value. The heights of the plurality of droplets in the computational element can be computed based on the volume of the droplets and wettability of the curable composition IM with respect to the substrate S. If, for example, the shape of the curable composition IM is part of a spherical surface, the height h_{drp,i} of the droplets can be computed based on a contact angle θ of the curable composition IM with respect to the substrate S and a volume V of the droplets of the curable composition IM by equation (1) below. Equation (1) has an advantage that the height of the droplets can be computed easily and has a disadvantage that the accuracy decreases in a system in which the contact angle θ approaches 0.

$${h}_{d r p , i} = {( 1 - cos θ ) [ \frac{V}{π} {( \frac{2}{3} - cos θ + \frac{1}{3} {cos}^{3} θ )}^{- 1} ]}^{1 / 3} \qquad ( 1 )$$

Alternatively, a table indicating the mutual relationship among the volume V of the droplets, the contact angle θ of the curable composition IM with respect to the substrate S, and the height h_{drp,i} of the droplets is prepared in advance, and then the height h_{drp,i} of the droplets may be obtained from the table based on the volume V of the droplets and the contact angle θ. Alternatively, in addition to the volume V of the droplets and the contact angle θ, an elapsed time (the elapsed time influences evaporation of the curable composition and the spreading shape of the droplets) since provision of the curable composition IM to the substrate S and the like may be taken into consideration to obtain the height h_{drp,i} of the droplets.

A computation step including steps S303, S304, and S305 is executed for a plurality of preset times. The plurality of times can arbitrarily be set within a period from a time when the mold M starts to lower from the initial position until a time when the mold M contacts a plurality of droplets, the plurality of droplets are crushed to spread, and are connected to each other to finally form one film, and the curable composition should be cured. The plurality of times can typically be set at a predetermined time interval.

In step S303, the state of the droplets is determined for each of the plurality of computational elements forming the computational grid. As the state of the droplets, various states can be considered. In one example, the state of droplets includes a state in which the droplets are not in contact with the mold M and a state in which the droplets are in contact with the mold M. The state in which the droplets are not in contact with the mold M and the state in which the droplets are in contact with the mold M can be determined for each computational element by comparing the height h_{drp,i} of the droplets and the distance hᵢ between the substrate S and the mold M to each other. More specifically, if hᵢ<h_{drp,i}, it can be determined for the computational element i that the droplets are in contact with the mold M.

Furthermore, the state of the droplets after the droplets contact the mold M can be classified into a plurality of states. The state of the droplets after the droplets contact the mold M can be determined based on an index value βᵢ (to be described below).

The index value βᵢ can be defined as a ratio between the total volume V_{drp,i} of the droplets in the computational element i and the volume of a space between the surface of the substrate S and that of the mold M in the droplet arrangement region of the computational element i. More specifically, the index value βᵢ can be defined by equation (2) below.

$${β}_{i} = \frac{{V}_{d r p , i}}{{α}_{i} ( {S}_{i} {h}_{i} + {V}_{p t n , i} )} \qquad ( 2 )$$

where αᵢ represents a ratio between the area of the droplet arrangement region in the computational element i and the area of the computational element i, as exemplified in FIG. 9. αᵢ(Sᵢhᵢ+V_{ptn,i}) represents the volume of the space between the surface of the substrate S and that of the mold M in the droplet arrangement region of the computational element i.

As is apparent from the above description, the index value βᵢ is a value that can be decided without evaluating the shape of each droplet. That is, to obtain the index value βᵢ, fluid dynamics computation performed by setting a computational grid so as to resolve individual droplets is unnecessary.

The index value βᵢ corresponds to the ratio between the total sum of the areas of the droplets when viewing the computational element from above and an area Sᵢ of the computational element. Therefore, the index value βᵢ can be understood as the coverage or filling rate of the area of the droplets with respect to the area of the computational element. The index value βᵢ may be defined by equation (3) below. The index value may be regarded as the filling rate.

$${β}_{i} = \frac{1}{{S}_{i}} {\sum }_{j ∈ D R {P}_{i}} {S}_{drp , j} \qquad ( 3 )$$

where S_{drp,j} represents the area of the jth droplet, and DRPᵢ represents a set of the numbers of droplets included in the ith computational element i.

Next, the state of the curable composition IM can be determined for each computational element based on the index value βᵢ. This determination process can be performed with reference to a classification table that associates the index value βᵢ and the state of the curable composition IM with each other. The classification table may be created in advance, and incorporated in the simulation program 21 or stored in a memory such as the memory 20 so as to be referred to by the simulation program 21.

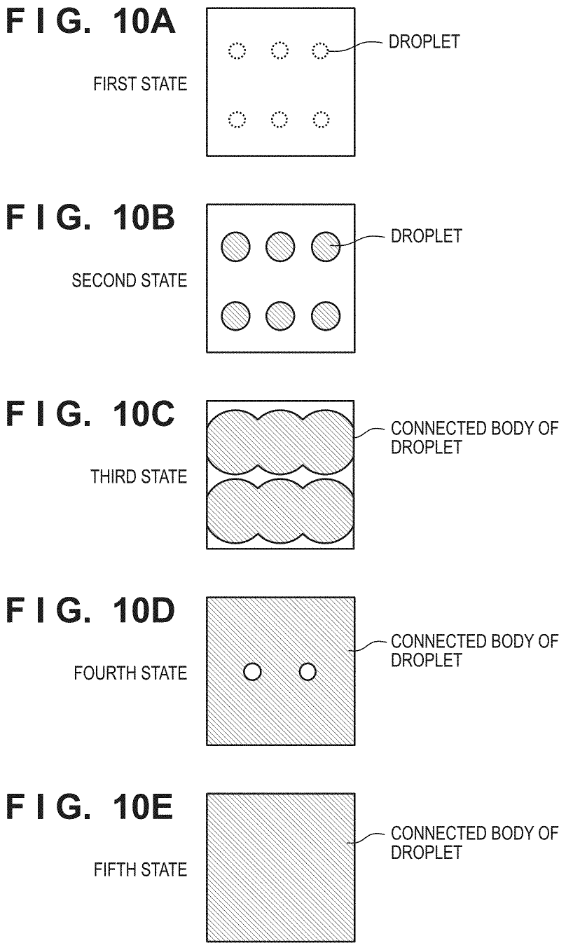

FIGS. 10A to 10E each exemplify the state of the curable composition IM. In the example shown in FIGS. 10A to 10E, the state of the curable composition IM is classified into five states of the first to fifth states. The first state can be a state in which the plurality of droplets of the curable composition IM in the computational element and the mold M are not in contact with each other. The second state can be a state in which the plurality of droplets of the curable composition IM in the computational element and the mold M are in contact with each other and the plurality of droplets are not connected to each other. The third state can be a state in which the plurality of droplets of the curable composition IM in the computational element and the mold M are in contact with each other, the droplets arranged in the first direction among the plurality of droplets are connected to each other, and the droplets arranged in the second direction among the plurality of droplets are not connected to each other. The fourth state can be a state in which the plurality of droplets of the curable composition IM in the computational element and the mold M are in contact with each other, all of the plurality of droplets are connected to each other to form a connected body, and there are bubbles in the connected body. The fifth state can be a state in which the plurality of droplets of the curable composition IM in the computational element and the mold M are in contact with each other, all of the plurality of droplets are connected to each other to form a connected body, and there is no bubble in the connected body.

From another viewpoint, the state of the curable composition IM can be considered to include a non-connected state in which the plurality of droplets of the curable composition IM in the computational element are not connected to each other and a connected state in which the plurality of droplets of the curable composition IM in the computational element are connected to each other. The first and second states are non-connected states and the third, fourth, and fifth states are connected states.

As the classification table that associates the index value Pi and the state of the curable composition IM with each other, one classification table may be used regardless of the arrangement pattern of the droplets of the curable composition IM in the computational element. However, a criterion to determine the state of the curable composition IM may be changed based on the arrangement pattern of the plurality of droplets of the curable composition IM in the computational element. More specifically, a plurality of classification tables may be prepared in accordance with the arrangement pattern of the droplets of the curable composition IM. The arrangement pattern of the droplets of the curable composition IM can be the arrangement pattern of the droplets in the computational element in a state before the curable composition IM and the mold M contact each other.

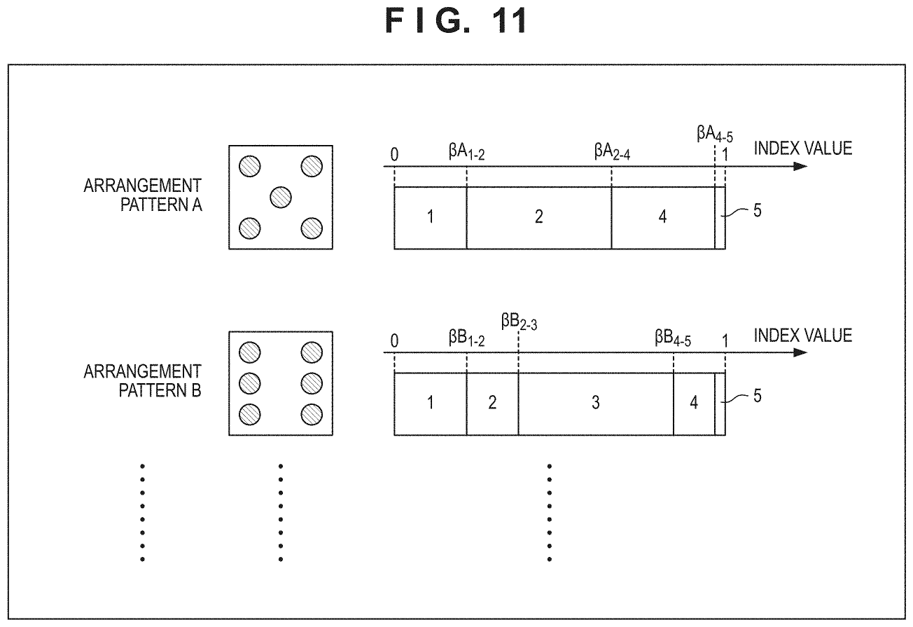

FIG. 11 shows an overview of the classification table in accordance with the arrangement pattern of the droplets of the curable composition IM. In FIGS. 11, 1 to 5 indicate the first to fifth states, respectively. As for an arrangement pattern A, when the index value βᵢ satisfies 0<βᵢ<βA₁₋₂, the state of the curable composition IM of the computational element i is the first state. As for the arrangement pattern A, when the index value βᵢ satisfies βA₁₋₂<βᵢ<βA₂₋₄, the state of the curable composition IM of the computational element i is the second state. As for the arrangement pattern A, when the index value βᵢ satisfies βA₂₋₄<βᵢ<βA₄₋₅, the state of the curable composition IM of the computational element i is the fourth state. As for the arrangement pattern A, when the index value βᵢ satisfies βA₄₋₅<βᵢ<1, the state of the curable composition IM of the computational element i is the fifth state. As for the arrangement pattern A, the state transitions from the second state to the fourth state without transitioning to the third state.

To create such classification table, general fluid dynamics computation can be used. In fluid dynamics computation, for example, the behavior of the curable composition in the computational element as a region extremely smaller than a shot region is only computed, and thus computation can end within a sufficiently short time. Furthermore, a classification table created in the past can also be used for a similar arrangement pattern.

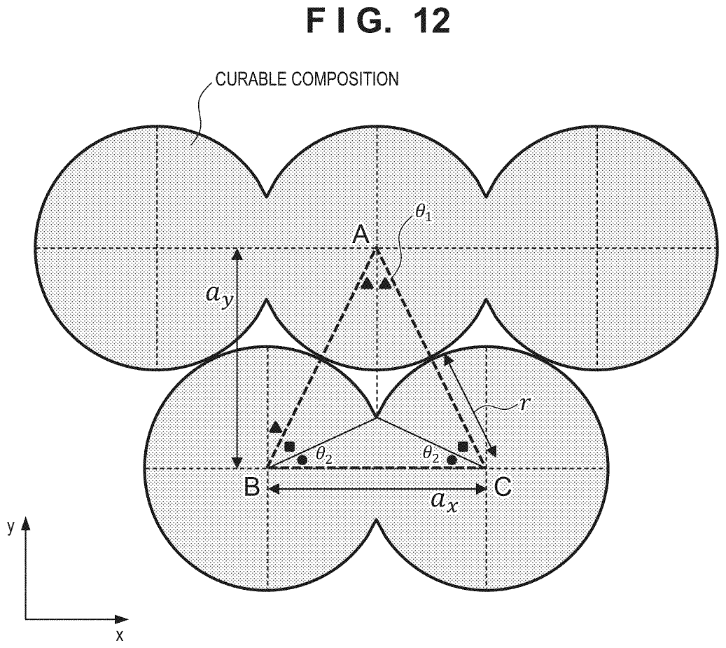

A classification table may be created by geometric computation. As an example, as shown in FIG. 12, consider an arrangement pattern in which aₓ represents a pitch in the x direction, a_{y} represents a pitch in the y direction, and droplets are alternately arranged. The index value β₃₋₄ at a timing when the state shifts from the third state shown in FIG. 10C to the fourth state shown in FIG. 10D, that is, a timing when bubbles are trapped is computed. An area Sᵣₑₛ of the droplets included in a region of a triangle ABC in FIG. 12 is given by equation (4) below.

$${S}_{res} = \frac{1}{4} ( \frac{π}{2} - {θ}_{2} ) ( \frac{{a}_{x}^{2}}{4} + {a}_{y}^{2} ) + \frac{1}{4} {a}_{x}^{2} tan {θ}_{2} \qquad ( 4 )$$

where r, θ₁, and θ₂ are given by equations (5) below.

$$r = \frac{1}{2} \sqrt{{a}_{x}^{2} / 4 + {a}_{y}^{2}} \\ {θ}_{1} = {tan}^{- 1} ( \frac{{a}_{x}}{2 {a}_{y}} ) \\ {θ}_{2} = {cos}^{- 1} ( \frac{{a}_{x}}{2 r} ) \qquad ( 5 )$$

Using Sᵣₑₛ, the index value β₃₋₄ can be given by equation (6) below.

$${β}_{3 - 4} = \frac{2 {S}_{r e s}}{{a}_{x} {a}_{y}} \qquad ( 6 )$$

As described above, a classification table can be created without using the general fluid dynamics computation.

In step S304, for each of the plurality computational elements forming the computational grid, a model (for example, a formula) corresponding to the state of the curable composition IM determined in step S303 is set. A plurality of models (first to fifth models) respectively corresponding to the plurality of states (in this example, the first to fifth states) of the curable composition IM are created in advance. The plurality of models may be incorporated in the simulation program 21 or stored in a memory such as the memory 20 so as to be referred to by the simulation program 21. In step S304, a model corresponding to the state of the curable composition IM determined in step S303 is selected from the plurality of models created in advance. The first and second models corresponding to the first and second states can be understood as non-connected state model, and the third, fourth, and fifth models corresponding to the third, fourth, and fifth states can be understood as connected state models. That is, the connected state models can include a plurality of models corresponding to stages in which a film is formed by a plurality of droplets of the curable composition IM in the computational element.

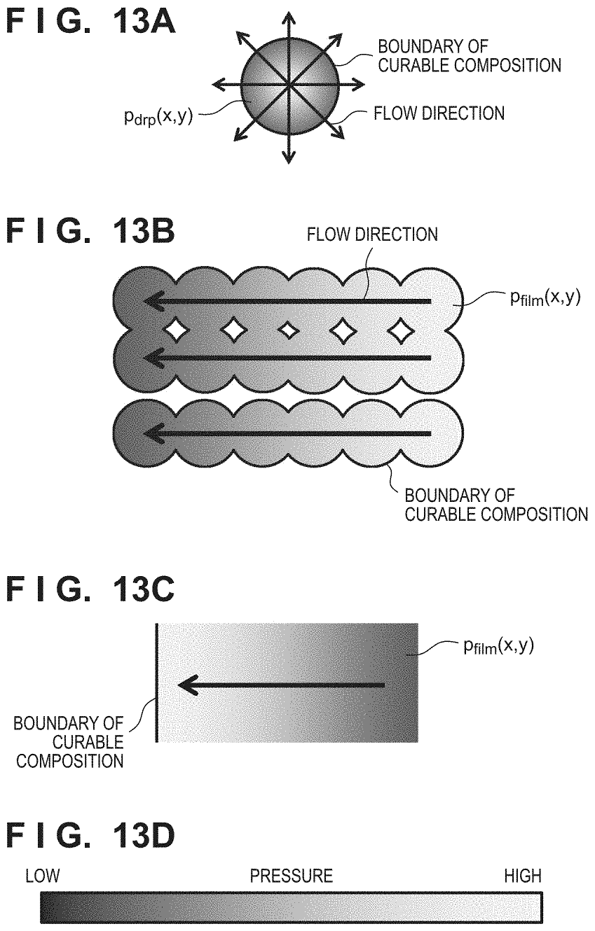

The pressure distribution p(x, y) of the curable composition IM can be understood to have two components. One is the pressure distribution of the flow of the curable composition IM generated when the droplets of the curable composition IM are pressed by the mold M to spread, which is represented by p_{drp}(x, y). The other is a pressure distribution generated when the curable composition IM flows in a liquid film formed by a connected body obtained when the plurality of droplets are connected, which is represented by p_{film}(x, y). FIG. 13A exemplifies the pressure distribution p_{drp}(x, y) in the grayscale. FIGS. 13(b) and 13(c) each exemplify the pressure distribution p_{film}(x, y) in the grayscale. FIG. 13D exemplifies the relationship between a tone and a pressure in the grayscale shown in FIGS. 13A, 13B, and 13C.

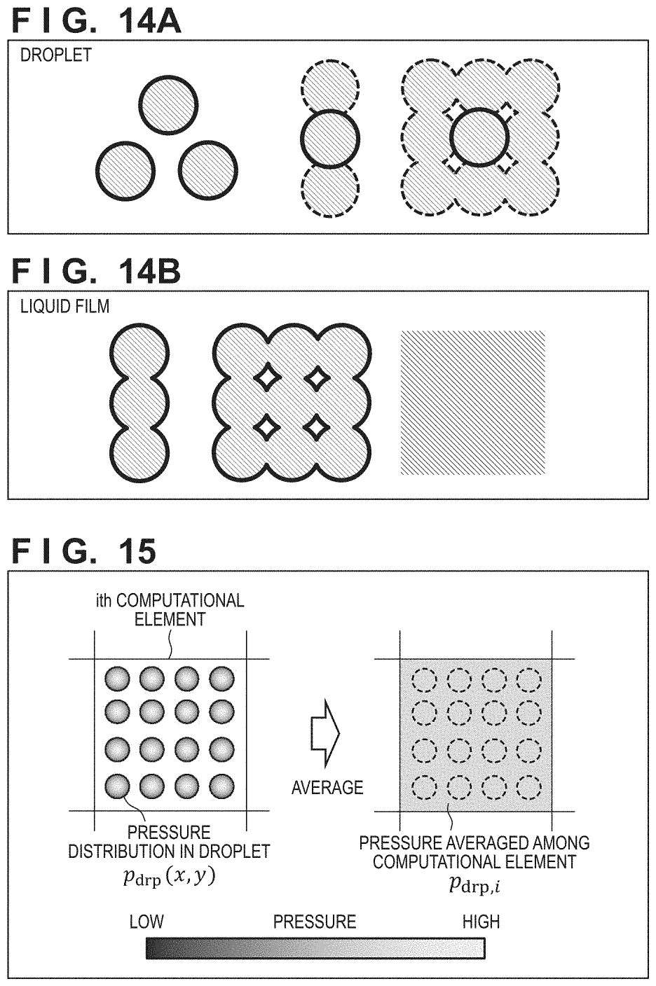

FIG. 14A exemplifies droplets of the curable composition IM. Each droplet is an individual clump of the curable composition IM in a computational element in a state in which there exists a space (unfilled space) including no curable composition, that is, the index value βᵢ is smaller than 1. FIG. 14B exemplifies a liquid film of the curable composition IM. The liquid film is the entire connected body obtained when a plurality (at least one) of droplets are connected to each other. The pressure distribution p(x, y) of the curable composition IM is given by equation (7) below.

p(x,y)=p_{drp}(x,y)+p_{film}(x,y) (7)

In general, p_{drp}(x, y) has a steep space distribution of about the size of a droplet, and p_{film}(x, y) has a space distribution that is gentler than p_{drp}(x, y). To obtain the pressure distribution p_{drp}(x, y) generated when the droplet flows, fluid dynamics computation performed by setting a computational grid so as to resolve the droplets is essential. On the other hand, in this embodiment, instead of obtaining the pressure distribution p_{drp}(x, y) of each droplet, one pressure p_{drp,i} is obtained for one computational element i, as shown in FIG. 15. This largely reduces the computation cost.

More specifically, in this embodiment, the average value of the pressure distribution p_{drp}(x, y) in the computational element i is obtained, and is set as the pressure p_{drp,i} for the computational element i. The pressure p_{drp,i} can be given by equation (8) below.

$${p}_{drp , i} = \frac{1}{{S}_{i}} {\int }_{{Ω}_{i}} {p}_{d r p} ( x , y ) dx d y = \frac{1}{{S}_{i}} {\sum }_{j ∈ D R {P}_{i}} {P}_{drp , j} \qquad ( 8 )$$

where Sᵢ represents the area of the ith computation component i, represents the region of the ith computation component i, DRPᵢ represents a set of droplets included in the ith computation component i, and p_{drp,j} represents a force generated by each droplet. If a space including no curable composition IM remains in the computational element i, the pressure p_{drp,i} generated by a droplet can be given by equation (9) below.

p_{drp,i}=Aᵢ+Bᵢh′ᵢ (9)

where Aᵢ represents a term corresponding to the meniscus pressure of the curable composition IM, and Bᵢ represents a resistance coefficient proportional to a speed h′ᵢ (differentiation of hᵢ) of the mold M. The coefficient Aᵢ depends on the surface tension of the curable composition IM, and the coefficient Bᵢ depends on the viscosity of the curable composition IM. Both the coefficients Aᵢ and Bᵢ depend on the distance hᵢ between the substrate S and the mold M, and also depend on the connected state of the droplets. Therefore, in this embodiment, a formula (model) representing the coefficients Aᵢ and Bᵢ is changed in accordance with the state (first to fifth states) of the curable composition IM determined in step S303. That is, the first model is set for the first state, the second model is set for the second state, the third model is set for the third state, the fourth model is set for the fourth state, and the fifth model is set for the fifth state.

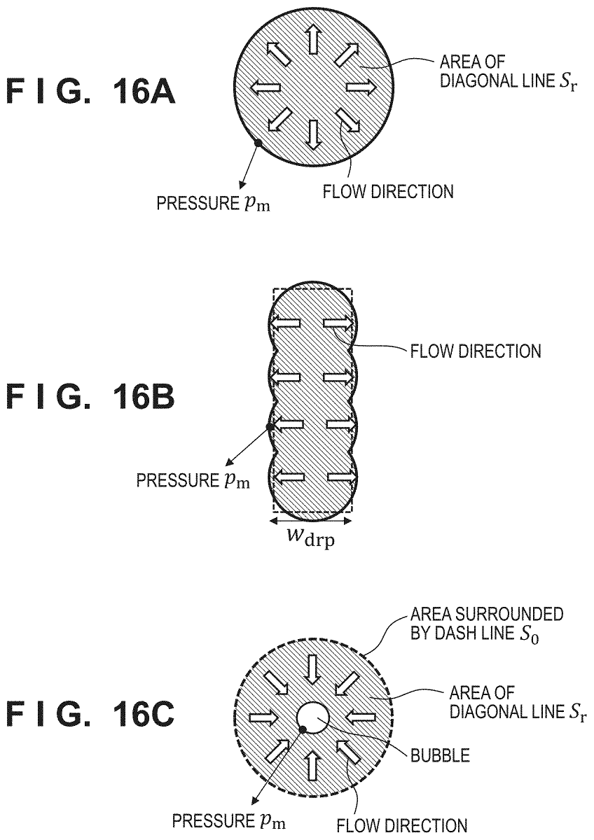

FIGS. 16A to 16C show variables used in the following description. FIG. 16A exemplifies the curable composition in the second state. FIG. 16B exemplifies the curable composition in the third state. FIG. 16C exemplifies the curable composition in the fourth state.

In the first state, since the curable composition IM and the mold M are not in contact with each other, the curable composition IM does not make a force act on the mold M. Therefore, the coefficients Aᵢ and Bᵢ defining the first model are both 0.

In the second state, individual droplets of the curable composition IM are independent of each other. Therefore, as shown in FIG. 16A, the shape of a droplet can be approximated by a circle. The force p_{drp,i} generated by one droplet can be obtained by integrating, in a droplet area i, the pressure distribution obtained by solving a general fluid dynamics equation. Since the height of a channel, that is, the distance hᵢ between the substrate S and the mold M is sufficiently small with respect to the spreading area of the droplet, a lubrication equation can be applied. When μ represents the viscosity of the curable composition IM and hᵢ represents the height of the channel, the lubrication equation is given by equation (10) below.

$$∇ \cdot ( - \frac{{h}^{3}}{12 μ} ∇ {p}_{d r p , i} ) + {h}_{i}^{′} = 0 \qquad ( 10 )$$

A solution obtained by solving equation (10) under a boundary condition that the pressure p_{drp,i} is equal to a meniscus pressure pₘ in the end portion of a droplet is integrated by a region where one droplet exists, thereby obtaining equation (11) below. An equation of obtaining the product of the force P_{drp,i} and the number of droplets in the computational element i is the second model. That is, the second model as a non-connected state model is a model having, as variables, the characteristic (P_{drp,i}) of a droplet representing the plurality of droplets of the curable composition IM in the computational element i and the number of the plurality of droplets.

$${P}_{d r p , i} = {S}_{r} {p}_{m} - \frac{3 μ {S}_{r}^{2}}{2 π {h}^{3}} {h}_{i}^{′} \qquad ( 11 )$$

where Sᵣ represents the area of the droplet. The meniscus pressure pₘ can be decided by the distance hᵢ between the substrate S and the mold M, the surface tension of the curable composition, the contact angle of the curable composition with respect to the substrate S and the mold M, the shape of the pattern of the mold M, and the like.

In the third state, as exemplified in FIG. 16B, a liquid film formed by a connected body of a plurality of droplets can be approximated by a rectangular region. If the solution of the above-described lubrication equation (equation (10)) is used, equation (12) below can be obtained as the third model.

$${P}_{drp , i} = \frac{{V}_{0}}{h} {p}_{m} - {μ ( \frac{{w}_{d r p}}{h} )}^{3} \frac{{V}_{0}}{h {w}_{d r p}} {h}_{i}^{′} \qquad ( 12 )$$

where w_{drp} represents the width of the approximated rectangular region, which corresponds to the width of the liquid film formed by the connected body of the plurality of droplets, and V₀ represents the volume of one droplet.

In the fourth state, a bubble exists in a liquid film formed by a connected body of a plurality of droplets. As exemplified in FIG. 16C, the region of the bubble is approximated by a cylindrical column, the liquid region of a columnar shape surrounding the cylindrical column is considered, and the equation of the flow within the liquid region is integrated, thereby making it possible to compute the force P_{drp,i} generated by the droplet. If the solution of the above-described lubrication equation (equation (10)) is used, equation (13) below can be obtained as the fourth model.

$${P}_{drp , i} = {S}_{0} {p}_{g} + {S}_{r} {p}_{m} - \frac{3 μ}{2 π {h}^{3}} [ 2 {S}_{0} ( {S}_{0} ln \frac{{S}_{0}}{{S}_{0} - {S}_{r}} - {S}_{r} ) - {S}_{r}^{2} ] {h}_{i}^{′} \qquad ( 13 )$$

where p_{g} represents the pressure of the trapped bubble, S₀ represents the area of the columnar region, and Sᵣ represents an area obtained by excluding the area of the bubble from the columnar region, that is, a spreading area of the curable composition IM.

The fifth state is a state in which all the droplets in the computational element i are connected to each other and all the space in the computational element i is filled with the curable composition IM. Therefore, in the fifth state, a steep pressure component p_{drp}(x, y) does not exist anymore, and only the pressure component p_{film}(x, y) of the liquid film exists. Since the pressure distribution in the pressure component p_{film}(x, y) of the liquid film is gentle, it may be considered that the pressure components p_{film}(x, y) are averaged in the computational element i and a uniform pressure value is taken in the computational element i. The flow pressure of the liquid film representing the ith computational element i is represented by p_{film,i}. The flow pressure of the liquid film can be obtained by solving, on the computational grid, a fluid dynamics equation concerning the flow of the curable composition IM. The volume preservation equation of the curable composition IM concerning the computational element i is given by equation (14) below.

∫_{Ω}_{ᵢ}∇·q_{film}(x,y)dxdy+Sᵢh′ᵢ+V′_{void,i}=0 (14)

where q_{film} represents the flow flux of the curable composition IM in the liquid film, h′ᵢ represents the speed of the mold M, and V′_{void,i} represents the change rate of the volume of unfilled space (a space where there is no curable composition IM) in the computational element i. When the index value βᵢ is equal to 1, V′_{void,i} becomes 0. By using the fact that the liquid film of the curable composition IM is very thin and using, as the fifth model, equation (15) applied with lubrication approximation, it is possible to largely suppress the computation amount.

$${\int }_{{Ω}_{i}} ∇ \cdot ( - \frac{{h}^{3}}{12 μ} ∇ {p}_{film} ) dxd y + {S}_{i} {h}_{i}^{′} + {V}_{νo id , i}^{′} = 0 \qquad ( 15 )$$

Since equation (15) refers to the value of an adjacent computational element, it is necessary to solve simultaneous equations.

In step S305, the motion of the mold M and the flow of the curable composition IM are computed for all the plurality of computational elements for each of which the model has been set in step S304. That is, in step S305, the motion of the mold M and the flow of the curable composition IM are solved using the formula set for each computational element in step S304, and the position and speed of the mold M and the flow state of the curable composition at a new time which is advanced by a set time step are computed.

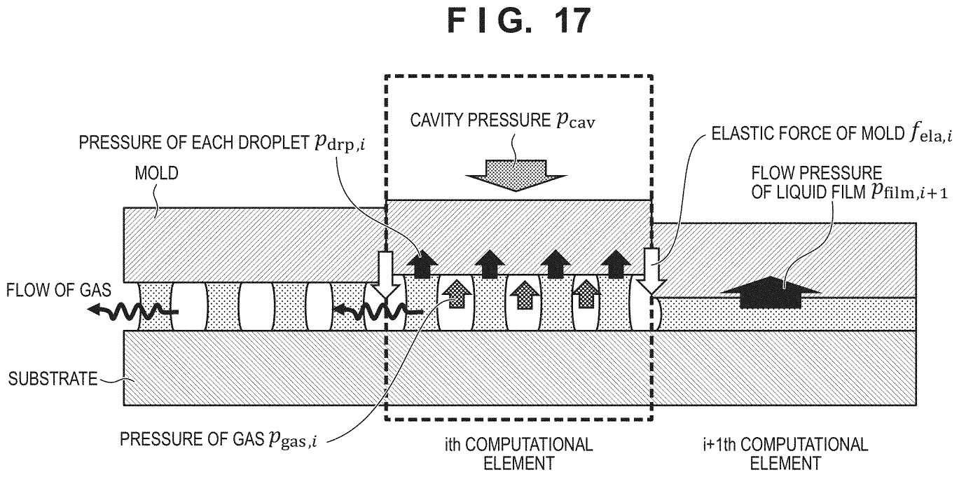

FIG. 17 shows the variables that can be considered in step S305. A cavity pressure is the pressure of the space SP. The equation of motion of the mold M in the computational element i can be decided by the inertia of the mold M, the flow pressure of a droplet, the flow pressure of the liquid film, a load applied to the mold M, the pressure of a gas existing between the substrate S and the mold M, a restoring force by elastic deformation of the mold M, and the like. The equation of motion can be given by equation (16) below.

p_{film,i}+p_{drp,i}+p_{gas,i}+p_{cav}+f_{ela,i}−ch′ᵢ−ρh″ᵢ=0 (16)

where c represents an energy dissipation coefficient, p_{cav} represents the pressure (cavity pressure) of the space SP, f_{ela,i} represents the elastic restoring force of the mold M, and ph″ᵢ represents an inertial force. A general elastodynamic equation can be applied to computation of the restoring force by elastic deformation of the mold M. Since the elastic restoring force is generally decided with reference to an adjacent computational element, the equation of motion of equation (15) also becomes a simultaneous equation on the computation grid.

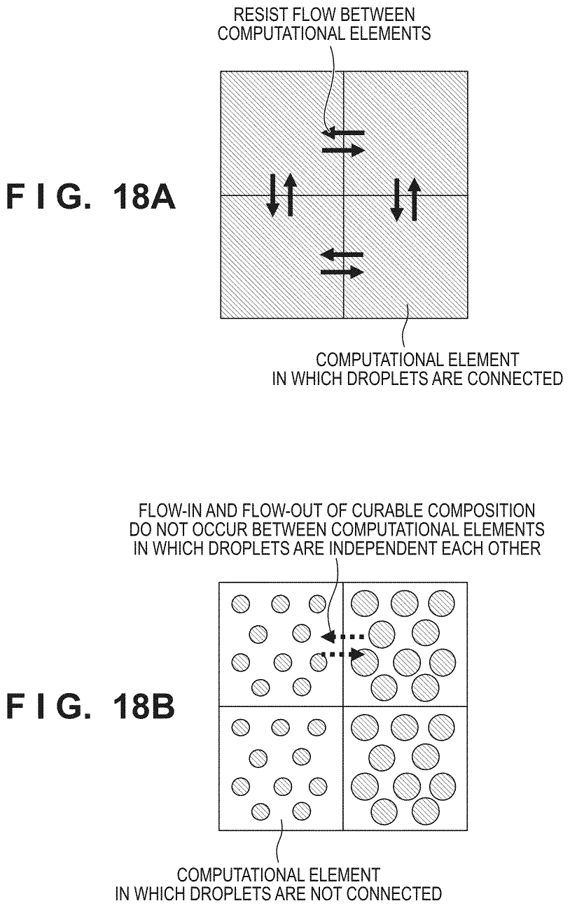

Consider the flow of the curable composition between the computational elements. As shown in FIGS. 18A and 18B, if all the droplets included in two computational elements of interest are independent of each other, it can be considered that the flow of the curable composition across the two computational elements does not occur. On the other hand, it can be considered that the curable composition flows in and out between the computational elements in which the droplets are determined to be connected to each other. The flow-in and flow-out of the curable composition are decided by an equation of computing the flow pressure of the liquid film. That is, by solving equation (17) below, the flow-in and flow-out of the curable composition can be obtained.

∫_{Ω}_{ᵢ}∇·q_{film}(x,y)dxdy+Sᵢh′ᵢ+V′_{void,i}=0 (17)

In this example, q_{film}(x, y) can be represented as a function of the flow pressure p_{film}(x, y) of the liquid film. Equation (16) also becomes a simultaneous equation on the computational grid, and p_{film}(x, y) obtained here is also included in the equation of motion of the mold M.

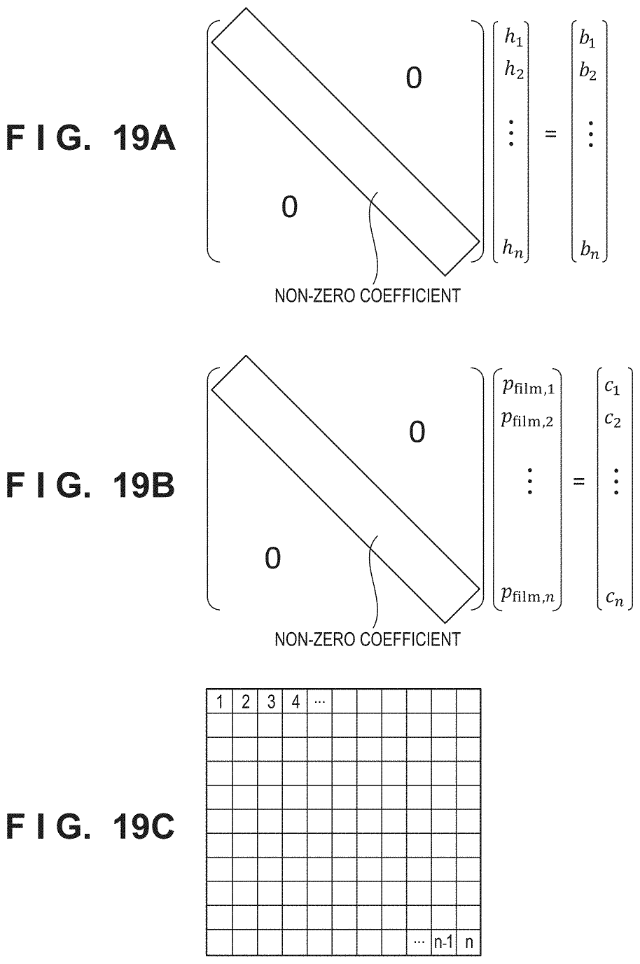

By forming simultaneous equations of the equation of motion of the mold M and the flow equation of the curable composition IM, and solving the simultaneous equations on the computational grid, it is possible to decide the position and speed of the mold M at a new time. At the same time, it is possible to compute the flow amount of the curable composition IM between computational elements and compute the thickness of a liquid film in each computational element. FIGS. 19A to 19C conceptually show the simultaneous equations to be solved. The right-hand sides of the simultaneous equation of the variable hᵢ and that of the variable p_{film,i} are functions of each other's variables. Thus, it is necessary to simultaneously solve the simultaneous equations so as to satisfy them at the same time. The simultaneous equations can be numerically solved using a general numerical calculation algorithm.

In step S306, it is determined whether the time in computation has reached the end time. If the time has not reached the end time, the time advances to a next time, and the process returns to step S303; otherwise, the simulation method ends. In one example, in step S306, the current time is advanced by a designated time step, thereby setting a new computation time. Then, if the computation time has reached the predetermined end time, it is determined that computation is complete.

As described above, according to this embodiment, it is possible to compute, at a low computation cost, pieces of information of the state of the curable composition in each computational element, the thickness of a liquid film formed by a connected body of the curable composition, the position of the mold, and the like for the entire predetermined region (for example, the shot region) on the substrate S. If the index value βᵢ has not reached 1 in a given computational element, it is found that there is an unfilled defect in the computational element. Furthermore, if the thickness distribution of a liquid film exceeds an allowable value, it can be determined that a film not satisfying a desired quality requirement is formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A simulation method of predicting a behavior of a curable composition in a process of bringing a plurality of droplets of the curable composition arranged on a first member and a second member into contact with each other and forming a film of the curable composition on the first member, the method comprising:
defining a computational grid formed by a plurality of computational elements so that a plurality of droplets of the curable composition fall within one computational element, and
obtaining the behavior of the curable composition in each computational element in accordance with a model corresponding to a state of the curable composition in each computational element.

2. The simulation method according to claim 1, wherein the state includes a non-connected state in which the plurality of droplets of the curable composition in the computational element are not connected to each other, and a connected state in which the plurality of droplets of the curable composition in the computational element are connected to each other, and
the model includes a non-connected state model corresponding to the non-connected state and a connected state model corresponding to the connected state.

3. The simulation method according to claim 2, wherein
the non-connected state model is a model having, as variables, a characteristic of a droplet representing the plurality of droplets of the curable composition in the computational element and the number of the plurality of droplets, and
the connected state model is a model having, as a variable, a characteristic of a connected body formed when the plurality of droplets of the curable composition in the computational element are connected to each other.

4. The simulation method according to claim 3, wherein the non-connected state model and the connected state model are models that decide a force to be applied to the second member by the curable composition in the computational element.

5. The simulation method according to claim 3, wherein the connected state model includes a plurality of models corresponding to stages in which a film is formed by the plurality of droplets of the curable composition in the computational element.

6. The simulation method according to claim 1, wherein a state of the plurality of droplets is determined for each computational element based on a volume of a space between the first member and the second member and a volume of the curable composition in the computational element.

7. The simulation method according to claim 1, wherein a criterion to determine the state of the curable composition is changed based on an arrangement of the plurality of droplets of the curable composition in the computational element.

8. The simulation method according to claim 1, wherein the state includes
a first state in which the plurality of droplets of the curable composition in the computational element and the second member are not in contact with each other,
a second state in which the plurality of droplets of the curable composition in the computational element and the second member are in contact with each other and the plurality of droplets are not connected to each other,
a third state in which the plurality of droplets of the curable composition in the computational element and the second member are in contact with each other, droplets arranged in the first direction among the plurality of droplets are connected to each other, and droplets arranged in the second direction among the plurality of droplets are not connected to each other,
a fourth state in which the plurality of droplets of the curable composition in the computational element and the second member are in contact with each other, all of the plurality of droplets are connected to each other to form a connected body, and there is a bubble in the connected body, and
a fifth state in which the plurality of droplets of the curable composition in the computational element and the second member are in contact with each other, all of the plurality of droplets are connected to each other to form a connected body, and there is no bubble in the connected body, and
the model includes a first model, a second model, a third model, a fourth model, and a fifth model respectively corresponding to the first state, the second state, the third state, the fourth state, and the fifth state.

9. The simulation method according to claim 1, wherein the second member includes a pattern region having a pattern to be transferred to the curable composition.

10. The simulation method according to claim 9, wherein the state of the curable composition in each computational element is determined in consideration of unevenness of the pattern.

11. The simulation method according to claim 1, wherein the state of the curable composition in each computational element is determined in consideration of unevenness of a surface of the first member.

12. A non-transitory computer readable medium storing a program for causing a computer to execute a simulation method of predicting a behavior of a curable composition in a process of bringing a plurality of droplets of the curable composition arranged on a first member and a second member into contact with each other and forming a film of the curable composition on the first member, the method comprising:
defining a computational grid formed by a plurality of computational elements so that a plurality of droplets of the curable composition fall within one computational element, and
obtaining the behavior of the curable composition in each computational element in accordance with a model corresponding to a state of the curable composition in each computational element.

13. A simulation apparatus for predicting a behavior of a curable composition in a process of bringing a plurality of droplets of the curable composition arranged on a first member and a second member into contact with each other and forming a film of the curable composition on the first member, wherein
a computational grid formed by a plurality of computational elements is defined so that a plurality of droplets of the curable composition fall within one computational element, and
the behavior of the curable composition in each computational element is obtained in accordance with a model corresponding to a state of the curable composition in each computational element.
